(19) United States
(12) Patent Application Publication
(10) Pub. No.: US 2024/0426236 A1
(43) Pub. Date: Dec. 26, 2024

(54) METHOD AND CONTROL DEVICE FOR OPERATING A HYDRAULIC SYSTEM AND MOTOR VEHICLE WITH A HYDRAULIC SYSTEM

(71) Applicant: ZF Friedrichshafen AG, Friedrichshafen (DE)

(72) Inventors: Alexander Paul, Oberteuringen (DE); Juergen Weinrich, Radolfzell (DE); Martin Rossmann, Oberteuringen (DE); Adam Pauli, Bregenz (AT)

(73) Assignee: ZF Friedrichshafen AG, Friedrichshafen (DE)

(21) Appl. No.: 18/755,114

(22) Filed: Jun. 26, 2024

(30) Foreign Application Priority Data
Jun. 26, 2023 (DE) 10 2023 205 976.2

(51) Int. Cl. F01P 7/16; F01P 5/12

(52) U.S. Cl. CPC F01P 7/164; F01P 2005/125

(57) ABSTRACT

A method for operating a hydraulic system, in particular a hydraulic system of a motor vehicle, which comprises a hydraulic pump (10) powered by an electric motor (11) operated with rotation-speed regulation, the pump for drawing hydraulic oil from an oil sump (6) and supplying it to at least one assembly (8) that is to be cooled and/or lubricated. As a function of a temperature of the hydraulic oil and as a function of an actual electric current in the electric motor (11) powering the hydraulic pump (10) and/or an actual rotation speed of the hydraulic pump (10) or the electric motor (11) powering the pump, it is determined whether a sufficiently large oil supply is ensured for the at least one assembly (8) that is to be cooled and/or lubricated.

### RELATED APPLICATIONS

This application claims the benefit of and right of priority under 35 U.S.C. § 119 to German Patent Application no. 10 2023 205 976.2, filed on 26 Jun. 2023, the contents of which are incorporated herein by reference in its entirety.

### FIELD OF THE DISCLOSURE

The invention relates to a method and a control unit for operating a hydraulic system, and to a motor vehicle with a hydraulic system.

### BACKGROUND

Motor vehicles comprise a plurality of assemblies which have to be supplied with cooling fluid in order to cool and lubricate them. In a motor vehicle in the form of an electric or hybrid vehicle, these assemblies include in particular an electric motor which can be supplied, for example, with hydraulic oil as the coolant. For that purpose, the assembly to be cooled and/or lubricated is incorporated in a hydraulic system. The hydraulic system of a motor vehicle, into which the assembly to be cooled and/or lubricated is incorporated, comprises a hydraulic pump which draws hydraulic oil from an oil sump and delivers the oil to the assembly that is to be cooled and/or lubricated with hydraulic oil. The hydraulic pump is powered by an electric motor.

In the area of the hydraulic system a leak may occur, which can result in oil loss. If there is no longer enough hydraulic oil in the hydraulic system, this can result in a system pressure loss in the hydraulic system and in an extreme case to dry-running of the hydraulic pump. In such a case, no adequate cooling and/or lubrication can be guaranteed for the assemblies to be cooled and/or lubricated. It is also possible that during production sealing plugs, particularly in hydraulic lines, are not removed and accordingly no sufficiently large oil supply can be produced for the assemblies to be cooled and/or lubricated. A sufficiently large oil supply for the assemblies to be cooled and/or lubricated can also, for example, not be ensured in the event of a production defect such as the drilling of a hole in the hydraulic system that has been omitted or is unsuccessful, or if foreign particles are present in the hydraulic system. There is therefore a need for simple means with which it can be checked reliably whether a sufficient oil supply for at least one assembly that is to be cooled and/or lubricated can be ensured, and this without the need for a filling-level sensor of the oil sump or for an oil-pressure sensor.

DE 10 2017 210 885 A1 discloses a method for recognizing dry running of a pump device. As a function of a pump characteristic function and as a function of a timer function, a dry-running checking section is activated.

### SUMMARY

Starting from there, the purpose of the present invention is to provide a new type of method and control unit for operating a hydraulic system, and a motor vehicle with a hydraulic system.

This objective is achieved by a method, a control unit, and a motor vehicle according as disclosed herein.

According to the invention, as a function of a temperature of the hydraulic oil and as a function of an actual electric current in the electric motor that powers the hydraulic pump, and/or an actual rotation speed of the hydraulic pump or of the electric motor that powers the pump, it is determined whether a sufficient oil supply to the at least one assembly that is to be cooled and/or lubricated is ensured.

With the present invention it is proposed to determine, as a function of the temperature of the hydraulic oil, whether a sufficiently large oil supply is ensured to the at least one assembly that is to be cooled and/or lubricated. In this case, not only the temperature of the hydraulic oil is taken into account, but also an actual electric current in the electric motor that powers the hydraulic pump and/or an actual rotation speed of the hydraulic pump or that of the electric motor that powers the hydraulic pump.

The invention is based on the recognition that as a function of the temperature, the actual electric current in the electric motor that powers the hydraulic pump, and/or the actual rotation speed of the hydraulic pump or that of the electric motor powering the hydraulic pump, can be used advantageously to determine whether a sufficiently large oil supply to the at least one assembly to be cooled and/or lubricated is ensured.

Thus, depending on the temperature of the hydraulic oil, either the actual electric current in the electric motor that powers the hydraulic pump or the actual rotation speed of the hydraulic pump or that of the electric motor powering the hydraulic pump is better suited for the above determination. Furthermore, depending on the temperature of the hydraulic oil, both the actual electric current in the electric motor that powers the hydraulic pump or the actual rotation speed of the hydraulic pump or that of the electric motor powering the hydraulic pump can be used to determine whether a sufficiently large oil supply to the at least one assembly to be cooled and/or lubricated is ensured.

Thanks to the invention it is possible, as a function of the temperature of the hydraulic oil and on the basis of already existing measurement data, namely the actual current in the electric motor that powers the hydraulic pump and/or the actual rotation speed of the hydraulic pump or that of the electric motor powering the hydraulic pump, to monitor the guarantee of a sufficiently large oil supply. Thus, there is no need for an oil level sensor in the area of the oil sump or for an oil pressure sensor in the hydraulic system. Although the invention can be used particularly advantageously in a hydraulic system of a motor vehicle, the invention can also be used in other hydraulic systems.

Preferably, if the temperature of the hydraulic oil is higher than a first temperature-limit value, then as a function of the actual electric current in the electric motor powering the hydraulic pump it is determined whether a sufficiently large oil supply to the at least one assembly to be cooled and/or lubricated is ensured. At relatively high temperatures of the hydraulic oil the determination of whether a sufficiently large oil supply is ensured takes place on the basis of the temperature of the hydraulic oil and the actual current in the electric motor that powers the hydraulic pump. This is based on the recognition that at a relatively high oil temperature, the electric current in the electric motor powering the hydraulic pump is particularly suitable for determining whether the hydraulic pump is delivering enough oil.

Preferably, when the temperature of the hydraulic oil is lower than a second temperature-limit value, then as a function of the actual rotation speed of the hydraulic pump, or the electric motor powering the hydraulic pump, it is determined whether a sufficiently large oil supply to cool and/or lubricate the at least one assembly that is to be cooled and/or lubricated, is guaranteed. If the temperature of the hydraulic oil is relatively low, the determination of whether a large enough oil supply is guaranteed takes place on the basis of the actual rotation speed of the hydraulic pump or the electric motor powering it. This is based on the recognition that at low hydraulic oil temperatures the actual rotation speed is better suited than the actual electric current for determining whether a large enough oil supply is guaranteed.

The first and second temperature-limit values can be identical. If the first temperature-limit value and the second temperature-limit value differ from one another, and if the temperature of the hydraulic oil is lower than the first temperature-limit value and higher than the second temperature-limit value, then preferably, as a function of the actual electric current in the electric motor that powers the hydraulic pump or that of the electric motor powering it, and also as a function of the actual rotation speed of the hydraulic pump or that of the electric motor powering the pump, it is determined whether a sufficiently large oil supply to the at least one assembly to be cooled and/or lubricated is guaranteed. According to this further development of the invention, if the oil temperature is in a middle range, i.e., if it is lower than the first temperature-limit value but higher than the second temperature-limit value, the determination of a sufficiently large oil supply can be carried out on the basis of both the actual electric current and the actual rotation speed, preferably as a plausibility check.

### BRIEF DESCRIPTION OF THE DRAWINGS

Preferred further developments emerge from the subordinate claims and from the description given below. Example embodiments of the invention, to which it is not limited, are explained in greater detail with reference to the drawing, which shows:

FIG. 1: A drivetrain scheme of a motor vehicle,

FIG. 2: A hydraulic system scheme,

FIG. 3: A first diagram to clarify the invention, and

FIG. 4: A second diagram to clarify the invention.

### DETAILED DESCRIPTION

FIG. 1 shows, in a very schematic manner, a drivetrain scheme of a motor vehicle. The drivetrain of FIG. 1 comprises a drive aggregate 1 and a transmission 3 connected between the drive aggregate 1 and a drive output 2. The drive aggregate 1 can be an electric machine. FIG. 1 also shows a motor control unit 4 for controlling and/or regulating the operation of the drive aggregate 1, and a transmission control unit 5 for controlling and/or regulating the operation of the transmission 3. As shown in FIG. 1 the motor control unit 4 exchanges data with the drive aggregate 1 and the transmission control unit 5 with the transmission 3. Furthermore, the motor control unit 4 and the transmission control unit 5 exchange data with one another.

A motor vehicle comprises a plurality of assemblies, which have to be supplied with hydraulic oil to cool and/or lubricate them. In the drivetrain of FIG. 1 these include both the transmission 3 and the drive aggregate 1.

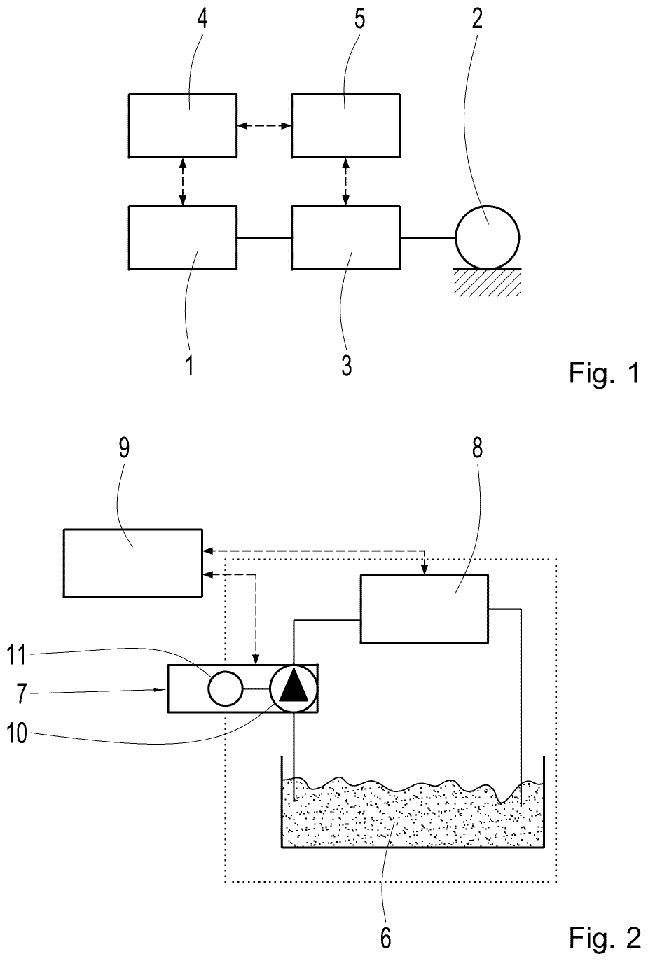

In order to supply the assemblies that must be cooled and/or lubricated with hydraulic oil, a motor vehicle comprises a hydraulic system, such as that shown schematically in FIG. 2. Thus, FIG. 2 shows an oil sump 6, a motor-pump unit 7 consisting of a hydraulic pump 10, and an electric motor 11 that powers the pump 10, as well as an assembly 8 to be cooled and/or lubricated, wherein the hydraulic pump 10 draws hydraulic oil from the oil sump 6 and serves to supply the assembly 8 to be cooled and/or lubricated with the hydraulic oil. The assembly 8 to be cooled and/or lubricated, shown in FIG. 2, for example, can be the drive aggregate 1 in the form of an electric machine, or the transmission 3 in FIG. 1. In this case, the electric motor 11 and thus the hydraulic pump 10 are rotation-speed-regulated.

FIG. 2 also shows a control unit 9. The control unit 9 exchanges data with the assembly 8 to be cooled and/or lubricated and also with the motor-pump unit 7. In the case of the motor vehicle shown in FIG. 1 the control unit 9 can be the motor control unit 4 or even the transmission control unit 5.

During operation, an oil leak may appear, resulting in a loss of oil. The consequence of this can be that there is no longer enough oil in the hydraulic system so that sufficient oil can no longer be supplied to the assembly 8 to be cooled and/or lubricated. In an extreme case, the hydraulic pump 7 may even run dry.

It is also possible that, for example, due to an assembly or production fault an oil line of the hydraulic system is blocked, for example because a transport plug has not been removed. In such a case too, no sufficiently large oil supply for the assembly to be cooled and/or lubricated can be ensured. The invention now relates to a method and a control unit for determining whether an oil supply sufficiently large for the at least one assembly to be cooled and/or lubricated is or can be ensured by the hydraulic system, and this without the need for a filling level sensor for the oil sump 6 and without the need for an oil pressure sensor in the hydraulic system.

According to the invention, as a function of the temperature of the hydraulic oil and as a function of an actual electric current in the electric motor 11 that powers the hydraulic pump 10, and/or as a function of an actual rotation speed of the hydraulic pump 10 or of the electric motor 11 that powers the hydraulic pump 10, it is determined whether a sufficiently large oil supply to the at least one assembly 8 to be cooled and/or lubricated is ensured.

The invention is based on the recognition that as a function of the temperature of the hydraulic oil, either the actual electric current in the electric motor 11 that powers the hydraulic pump 10, or the actual rotation speed of the hydraulic pump 10 or that of the electric motor 11 powering the hydraulic pump 10, or both of those actual values, i.e., both the actual electric current and the actual rotation speed, are particularly well-suited for determining whether a sufficiently large oil supply to the at least one assembly 8 to be cooled and/or lubricated is or can be ensured by the hydraulic system.

If the temperature of the hydraulic oil, which can be measured with the help of at least one temperature sensor, is higher than a first temperature-limit value, then as a function of the actual electric current in the electric motor 11 powering the hydraulic pump 10 it is determined whether a sufficiently large oil supply to the at least one assembly 8 to be cooled and/or lubricated is ensured. The actual electric current in the electric motor 11 powering the hydraulic pump 10 is a known, measurable, or calculable control parameter, wherein the actual current is in particular the actual phase current.

For the determination of whether a sufficiently large oil supply is ensured, if the temperature of the hydraulic oil is higher than the aforesaid first temperature-limit value, then both the actual value of the actual electric current as such and also a time gradient of the actual electric current can be taken into account. If, at a defined temperature of the hydraulic oil and also a defined target rotation speed of the rotation-speed-regulated electric motor 11 that powers the hydraulic pump 10, the actual value of the actual electric current is smaller than a target current and/or a time gradient of the actual electric current in the electric motor 11 is larger than a first gradient-limit value, it is concluded that a sufficiently large oil supply of the at least one assembly 8 to be cooled and/or lubricated is not being provided or ensured.

For the case that the temperature T of the hydraulic oil is higher than the first temperature-limit value, FIG. 3 shows the relationship between the oil pressure p delivered by the hydraulic pump 10 and the actual electric current I in the electric motor 11 powering the hydraulic pump 10 at various temperatures T of the hydraulic oil at a specified target rotation speed of the hydraulic pump 10. From FIG. 3 it can be seen that at high temperatures T of the hydraulic oil, which are higher than the first temperature-limit value, there is an approximately linear relationship between the actual electric current in the electric motor 11 that powers the hydraulic pump 10 and the oil pressure p delivered by the pump 10. For a plurality of target rotation speeds, characteristic lines as in FIG. 3 can be stored by the control system.

Thus, at a defined temperature T of the hydraulic oil which is higher than the first temperature-limit value, and at a defined target rotation speed of the electric motor 11 powering the hydraulic pump 10, the actual value of the actual electric current I in the electric motor 11 powering the hydraulic pump 10 is smaller than a target current which depends on a desired target pressure p, and can be determined in a temperature-dependent manner for example by way of the characteristic line in FIG. 3, so that it can be concluded that no sufficiently large oil supply is guaranteed.

Likewise, at temperatures T of the hydraulic oil which are higher than the first temperature-limit value, the time gradient of the actual electric current in the electric motor 11 powering the hydraulic pump 10 can be evaluated, in order to determine whether a sufficiently large oil supply is ensured. If at a defined target rotation speed of the electric motor 11 powering the hydraulic pump 10 the actual electric current I undergoes marked fluctuations, i.e. the time gradient of the actual electric current is larger than a first gradient limit value, it can again be concluded that a sufficiently large oil supply is no longer ensured. Both the actual current as such and also the time gradient of the actual current can be evaluated continuously by the control unit 9.

In a further development of the invention, it is possible, depending on the deviation between the actual value of the actual electric current in the electric motor 11 powering the hydraulic pump 10 and the target current determined as a function of the temperature of the hydraulic oil and the desired target pressure, and/or depending on the deviation of the time gradient of the actual electric current from the first gradient-limit value, for at least one alternative measure to be adopted, such as a warning message or even emergency operation of the hydraulic system. If the deviation is small, i.e., less than a corresponding limit value, then a warning message alone can be generated. But if the deviation is large, i.e., more than the corresponding limit value, then in addition emergency operation of the hydraulic system can be authorized in order, for example, to protect the hydraulic pump 10 against damage.

At a temperature T of the hydraulic oil which is higher than the first temperature-limit value, it is also possible, as a function of the temperature T of the hydraulic oil, as a function of the actual electric current I in the electric motor 11 that powers the hydraulic pump 10, and as a function of a defined target rotation speed of the electric motor 11 at which the electric motor should be operated, and as a function of the characteristic line shown in FIG. 3, to calculate a developing actual pressure p and to compare this with a desired target pressure. If the deviation between the actual pressure and the target pressure is larger than a corresponding limit value, then it can be concluded that a sufficiently large oil supply can no longer be ensured. Depending on the deviation between the actual pressure and the target pressure, at least one countermeasure can be adopted.

If the temperature of the hydraulic oil is lower than a second temperature-limit value, it is provided as a function of the actual rotation speed of the hydraulic pump 10, or the electric motor 11 powering it, to determine whether a sufficiently large oil supply is ensured. This is preferably done on the basis of a time gradient of the actual rotation speed.

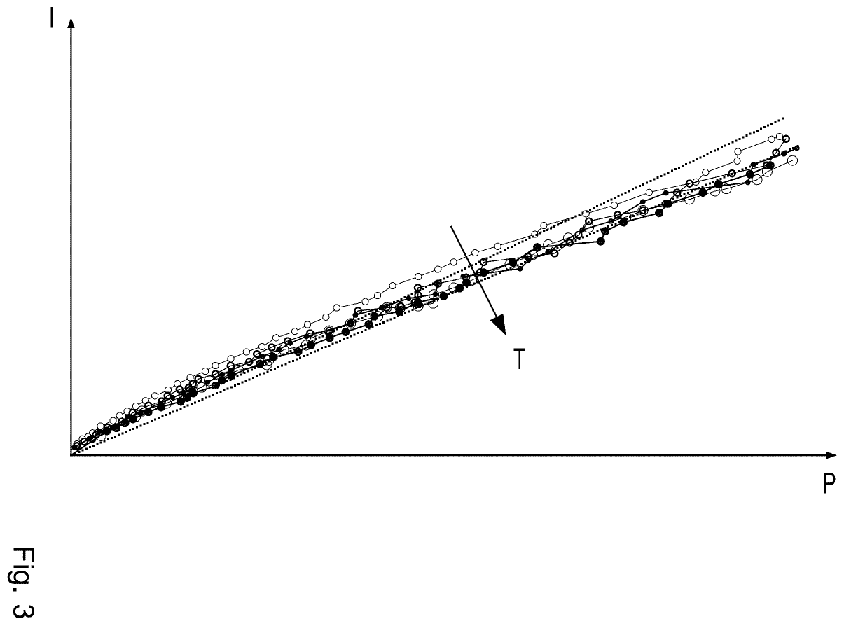

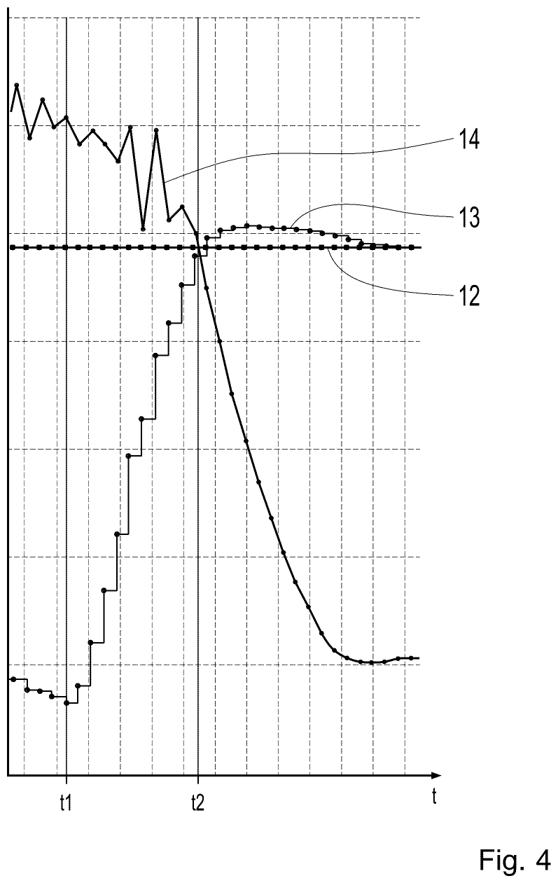

At a defined temperature of the hydraulic oil and also at a defined target rotation speed of the electric motor 11, which is operated with rotation-speed regulation and which serves to power the hydraulic pump 10, if the time gradient of the actual rotation speed is larger than a second gradient-limit value, then it is concluded that the hydraulic pump 10 no longer ensures a sufficiently large oil supply. FIG. 4 makes clear the procedure for determining whether a sufficiently large oil supply is ensured, in the case when the temperature of the hydraulic oil is lower than the second temperature-limit value and thus the temperature of the hydraulic oil is relatively low. In FIG. 4 a number of curve shapes plotted against time are shown, namely with curve 12 a target rotation speed for the electric motor 11 powering the hydraulic pump 10 and curve 13 an actual rotation speed of the motor. In FIG. 4 the curve 14 shows the actual electric current in the electric motor 11 that powers the hydraulic pump 10.

Before time-point t1, owing to the high viscosity of the hydraulic oil at low temperatures of the hydraulic oil, the actual rotation speed 13 of the motor 11 powering the hydraulic pump 10 is lower than the target rotation speed 12. Beginning at time-point t1 the actual rotation speed 13 of the motor 11 powering the hydraulic pump 10 increases rapidly, i.e., with a steep time gradient, toward the target rotation speed 12. Owing to the falling away of the load on the hydraulic pump 10 and therefore on the electric motor 11 due to the high viscosity of the oil, the electric motor 11 accelerates and so too does the hydraulic pump 10, with a steep time gradient, toward the target rotation speed 12. During the acceleration phase of the motor 11 between time-points t1 and t2, the actual electric current 14 in the motor remains almost unchanged. Only after the acceleration phase after time-point t2 does the actual electric current 14 decrease. At relatively low temperatures of the hydraulic oil, which are lower than the second temperature-limit value, the evaluation of the time gradient of the actual rotation speed 13 of the electric motor 11 powering the hydraulic pump 10 is therefore predominantly suitable for determining whether a sufficiently large oil supply is guaranteed.

If the temperature of the hydraulic oil is lower than the first temperature-limit value but higher than the second temperature-limit value, the determination of whether a sufficiently large hydraulic oil supply is ensured can be done as a function of the temperature of the hydraulic oil, as a function of the actual electric current in the electric motor 11 powering the hydraulic pump 10 and also as a function of the actual rotation speed of the hydraulic pump 10 or the electric motor 11 powering it. In this case the evaluation of the actual electric current can take place as described earlier for temperatures higher than the first temperature-limit value. The actual rotation speed can be evaluated as described earlier for temperatures lower than the second temperature-limit value. The results of these determinations can be used for a plausibility check, in which it is only concluded that a sufficient oil supply is no longer ensured if, on the one hand, the actual electric current is smaller than the target current and/or the time gradient of the actual electric current is smaller than the first gradient-limit value, and on the other hand the time gradient of the actual rotation speed is larger than the second gradient-limit value.

Alternatively, it is also possible to evaluate the two evaluation criteria on the basis of the actual current and on the basis of the actual rotation speed by means of an OR-gate, i.e., to conclude that there is no longer a sufficiently large oil supply if either the actual electric current is smaller than the target current and/or the time gradient of the actual electric current is larger than the first gradient-limit value, or the time gradient of the actual rotation speed is larger than the second gradient-limit value. The above evaluation criteria can also be weighted as a function of the temperature.

The first temperature-limit value and the second temperature-limit value can be identical. In particular, the first temperature-limit value is at +20° C. and the second temperature-limit value is at 0° C. However, those temperature-limit values are given purely as examples.

The above evaluation can take place during the on-going operation of the hydraulic system and hence too the operation of the motor vehicle at various temperatures.

The above monitoring can also be used at the end of a production process to check the proper assembly and hence functionality of a hydraulic system. Thus, at the end of a production process the hydraulic oil is typically at a defined temperature which is higher than the first temperature-limit value. As a function of this temperature of the hydraulic oil and a specified target rotation speed for the hydraulic pump 10, the actual electric current in the electric motor 11 powering the hydraulic pump 10 can be evaluated in order to check whether the hydraulic pump 10 is delivering a sufficient oil supply. Thus, as has been described above with reference to FIG. 3, from the actual current at the defined temperature of the hydraulic oil and for the defined target rotation speed of the hydraulic pump, on the basis of a characteristic line stored in the control unit the hydraulic pressure produced by the hydraulic pump 10 can be determined. If that pressure is high enough, it can be concluded that the oil supply is sufficiently large.

Furthermore, at the end of a production process and during the checking of the functionality of the hydraulic system, the electric motor 11 powering the hydraulic pump 10 can be put through a rotation speed ramp in order to determine, for selected rotation speeds along the rotation speed ramp, a reference characteristic line for the electric current in the electric motor 11. If over its lifetime it is found that at defined rotation speeds and at the temperature at which the reference characteristic line was determined the actual electric current in the electric motor 11 powering the hydraulic pump 10 deviates from the reference characteristic line determined, then it can be concluded that the hydraulic pump 10 or the electric motor 11 has aged or is defective.

The invention also relates to a control unit for operating a hydraulic system, in particular a hydraulic system of a motor vehicle. The control unit is designed to carry out the above-described method by control means. In addition, the invention relates to a motor vehicle with a hydraulic system and a control unit of that type.

The control unit which is designed to carry out the above-described method can be the transmission control unit 5. In that case, it is preferably an electronic control unit comprising hardware means and software means for carrying out the method according to the invention. The hardware means include data interfaces for the exchange of data with the assemblies involved in carrying out the method according to the invention, such as a sensor for detecting the temperature of the hydraulic oil with a sensor for detecting the actual electric current in the electric motor powering the hydraulic pump and/or a sensor for detecting the actual rotation speed of the hydraulic pump or the electric motor powering it. The sensors can be integrated in the motor-pump unit 7, for example. The data to be exchanged can be transmitted by way of a data bus such as a CAN bus (Controller Area Network). The hardware means also comprise a processor for data processing and a memory for data storage. The software means comprise program modules implemented in the control unit for carrying out the method according to the invention.

### INDEXES

1 Drivetrain
2 Drive aggregate
3 Drive output
4 Motor control unit
5 Transmission control unit
6 Oil sump
7 Motor-pump unit
8 Assembly
9 Control unit
10 Hydraulic pump
11 Electric motor
12 Target rotation speed curve shape
13 Actual rotation speed curve shape
14 Actual electric current curve shape

1. A method for operating a hydraulic system of a motor vehicle having a hydraulic pump (10) powered by an electric motor (11) operated with rotation-speed regulation, the hydraulic pump configured for drawing hydraulic oil from an oil sump (6) and supplying it to at least one assembly (8) that is to be cooled and/or lubricated, the method comprising:
determining, as a function of a temperature of the hydraulic oil and as a function of an actual electric current in the electric motor (11) powering the hydraulic pump (10) and/or an actual rotation speed of the hydraulic pump (10) or the electric motor (11) powering the pump, whether a sufficiently large oil supply is ensured for the at least one assembly (8) that is to be cooled and/or lubricated.

2. The method according to claim 1, comprising:
determining that the temperature of the hydraulic oil is higher than a first temperature-limit value; and
determining as a function of the actual electric current in the electric motor (11) powering the hydraulic pump (10) whether a sufficiently large oil supply is ensured.

3. The method according to claim 2, comprising evaluating an actual electric current and/or a time gradient of the actual electric current.

4. The method according to claim 3, comprising:
determining, at a defined temperature of the hydraulic oil and also at a defined target rotation speed of the hydraulic pump (10) or of the electric motor (11) powering it, that the actual electric current is lower than a target current and/or a time gradient of the actual electric current is larger than a first gradient-limit value; and
concluding that a sufficiently large oil supply for cooling and/or lubricating the at least one assembly to be cooled and/or lubricated is not ensured.

5. The method according to claim 4, comprising:
adopting at least one replacement measure as a function of a deviation between the actual electric current and the target current, and/or as a function of a deviation between the time gradient of the actual electric current and the first gradient-limit value.

6. The method according to claim 1, comprising:
determining that the temperature of the hydraulic oil is lower than a second temperature-limit value; and
determining, as a function of the actual rotation speed of the hydraulic pump (10) or the electric motor (11) powering the pump, it is determined whether a sufficiently large oil supply is ensured.

7. The method according to claim 6, comprising:
evaluating a time gradient of the actual rotation speed.

8. The method according to claim 7, comprising:
determining, at a defined temperature of the hydraulic oil and also at a defined target rotation speed of the hydraulic pump (10) or the electric motor (11) powering it, that the time gradient of the actual rotation speed is larger than a second gradient-limit value; and
concluding that the oil supply is not large enough for the at least one assembly to be cooled or lubricated.

9. The method according to claim 8, comprising:
adopting at least one replacement measure as a function of a deviation of the time gradient of the actual rotation speed from the second gradient-limit value.

10. The method according to claim 6, comprising:
determining that the temperature of the hydraulic oil is lower than the first temperature-limit value and higher than the second temperature-limit value; and
determining, as a function of the actual electric current in the hydraulic pump (10) and as a function of the actual rotation speed of the hydraulic pump (10) or the electric motor (11) powering the pump, whether a sufficiently large oil supply is ensured.

11. The method according to claim 10, comprising:
determining, at a defined temperature of the hydraulic oil and also at a defined target rotation speed of the hydraulic pump (10) or the electric motor (11) powering the pump, (i) that the actual electric current is smaller than the target current and/or that the time gradient of the actual electric current is larger than the first gradient-limit value, or (ii) that the time gradient of the actual rotation speed is larger than the second gradient-limit value; and
concluding that the hydraulic pump (10) is not ensuring a sufficiently large oil supply.

12. The method according to claim 10, comprising:
determining, at a defined temperature of the hydraulic oil and also at a defined target rotation speed of the hydraulic pump (10) or the electric motor (11) powering the pump, that (i) the actual electric current is smaller than the target current and/or the time gradient or the actual electric current is larger than the first gradient-limit value, or (ii) that the time gradient of the actual rotation speed is larger than the second gradient-limit value; and
concluding that the hydraulic pump (10) is not ensuring a sufficiently large oil supply.

13. The method according to a claim 1, wherein the method is carried out during on-going operation of the hydraulic system and/or in a production process of the hydraulic system at a conclusion of the production process.

14. A control unit for operating a hydraulic system of a motor vehicle, wherein the control unit is configured to automatically carry out the method according to claim 1 by control means.

15. A motor vehicle with a hydraulic system and a control unit configured to automatically carry out the method according to claim 1, by control means.
